(19) United States
(12) Patent Application Publication
(10) Pub. No.: US 2022/0194320 A1
(43) Pub. Date: Jun. 23, 2022

(54) BACKUP ENERGY SUPPLY AND AUTHENTICATION FOR ELECTRONIC LATCH

(71) Applicant: Magna Closures Inc., Newmarket (CA)

(72) Inventor: Stephen James CARON, Newmarket (CA)

(21) Appl. No.: 17/604,903

(22) PCT Filed: Apr. 24, 2020
(86) PCT No.: PCT/CA2020/050542

§ 371 Date: Oct. 19, 2021

Related U.S. Application Data
(60) Provisional application No. 62/845,481, filed on May 9, 2019.

(51) Int. Cl. B60R 25/40; E05B 81/76; E05B 81/82; E05B 81/78

(52) U.S. Cl. CPC B60R 25/403; E05B 81/77; E05B 2047/0094; E05B 81/78; E05B 81/82

(57) ABSTRACT

An entry backup energy assembly is provided for an electric latch that is powered by a main power source during a normal operating condition. The entry backup energy assembly includes a backup battery electrically coupled to an activation switch that is moveable to one of an activated state and a deactivated state. The entry backup energy assembly also includes a backup controller coupled to the activation switch and the backup battery and the electric latch. The backup controller is configured to receive power from the backup battery in response to movement of the activation switch to the activated state and wirelessly communicates with a user authentication unit to authenticate a user. The backup controller provides the backup electrical energy to the electric latch and enables the user to operate the electric latch during a failure operating condition in response to the user being authenticated.

### CROSS-REFERENCE TO RELATED APPLICATIONS

This PCT International Patent Application claims the benefit of U.S. Provisional Application No. 62/845,481 filed May 9, 2019. The entire disclosure of the above application being considered part of the disclosure of this application and hereby incorporated by reference.

### FIELD

The present disclosure relates generally to an entry system for a vehicle and, more particularly, to entry systems including an entry backup energy assembly for an electronic latch of a closure panel and a method of operating the entry system.

### BACKGROUND

This section provides background information related to the present disclosure which is not necessarily prior art.

It is desirable to have electrically activated latch assemblies in motor vehicles; however, one problem with such electrically activated latch assemblies is they may lack the ability to have the latch be activated (e.g., unlatched) to release and open the closure panel in a failure mode. Such failure modes may arise if the motor vehicle is in an accident and, for example, a power cable connecting a battery or other main power source to the electrically activated latch assembly is severed or damaged preventing the latch from operating correctly. In other situations, the main vehicle battery may have been depleted, for example, as a result of remaining in storage for an extended period of time. Thus, the main battery power may be insufficient to power operation of the latch correctly. Additionally, the loss or depletion of the main power source in a vehicle with electrically activated latch assemblies can lead to difficulty accessing the vehicle (e.g., opening a side door to gain access to a hood release) in order to remedy a loss or deficiency of the main power source.

To avoid these situations, the electrically activated latch assemblies may include a mechanical release which serves as a backup. Such a redundant mechanical release may act as a standby to the electrically activated latch assembly, but adds weight and assembly costs and further limits the design of the door or other closure panel.

In addition, many passenger vehicles and trucks are also now equipped with keyless entry systems alone or in combination with a traditional mechanical-type (e.g., keyed) entry system. Typically, the keyless entry system includes a portable device, such as a key fob, having pushbuttons that can be manipulated to unlock/lock the vehicle doors as well as perform other functions (e.g., selective activation of alarms, headlights and/or the ignition system) through encoded RF signals transmitted to a vehicle-installed receiver. In many instances, the signals supplied to the receiver are primarily used to control the selective locking and unlocking of a power-operated door latch mechanism and/or to provide user authentication prior to permitting entry into the vehicle. While such keyless entry systems have found widespread applications in vehicle door systems (e.g., passenger doors, tailgates and closure doors), the keyless operation and/or authentication described above may also be compromised or impeded due to the loss of a main power source of the vehicle.

Accordingly, there remains a need for improved entry systems and entry backup energy assemblies used in vehicles with corresponding methods of operation thereof that addresses, at least in part, the above-noted shortcomings and advances the art.

### SUMMARY

This section provides a general summary of the present disclosure and is not intended to be interpreted as a comprehensive disclosure of its full scope or all of its features, aspects and objectives.

Accordingly, it is an aspect of the present disclosure to provide an entry system for a closure panel of a vehicle that overcomes the above-noted shortcomings. The entry system includes an electric latch including and controlled by a latch control unit and including an actuation group coupled to the latch control unit and operable to latch and unlatch the closure panel using power from a main power source during a normal operating condition. The entry system also includes an entry backup energy assembly coupled to the electric latch. The entry backup energy assembly includes a backup battery for storing backup electrical energy and an activation switch electrically coupled to the backup battery and moveable by a user to one of an activated state and a deactivated state. Thus, the entry backup energy assembly provides backup electrical energy during a failure operating condition different from the normal operating condition. In addition, the entry system includes a user authentication unit carried by the user. The entry backup energy assembly includes a backup controller in communication with the user authentication unit and coupled to the activation switch and the backup battery and coupled to the electric latch. The backup controller is configured to receive power from the backup battery in response to movement of the activation switch to the activated state. The backup controller also wirelessly communicates with the user authentication unit to authenticate the user. The backup controller is further configured to provide the backup electrical energy from the backup battery to the latch control unit and the actuation group of the electric latch. Consequently, the backup controller enables operation of the electric latch during the failure operating condition in response to the user being authenticated and without further authentication of the user.

In another aspect of the disclosure, the activation switch of the entry backup energy assembly is disposed on an underside of an exterior rearview mirror of the motor vehicle.

In yet another aspect of the disclosure, the backup battery of the entry backup energy assembly is disposed in an exterior rearview mirror of the motor vehicle

In a further aspect of the disclosure, the backup battery of the entry backup energy assembly is an interchangeable back up battery and is provided in an exteriorly accessible compartment disposed in the exterior rearview mirror of the motor vehicle.

It is another aspect of the disclosure to provide an entry backup energy assembly for an electric latch for a closure panel of a vehicle powered by a main power source during a normal operating condition. The entry backup energy assembly includes a backup battery for providing backup electrical energy during a failure operating condition different from the normal operating condition. The entry backup energy assembly also includes an activation switch electrically coupled to the backup battery and moveable by a user to one of an activated state and a deactivated state. In addition, the entry backup energy assembly includes a backup controller coupled to the activation switch and the backup battery and to the electric latch. The backup controller is configured to receive power from the backup battery in response to movement of the activation switch to the activated state. The backup controller is also configured to wirelessly communicate with a user authentication unit to authenticate the user. The backup controller provides the backup electrical energy from the backup battery to the electric latch and enables the user to operate the electric latch during the failure operating condition in response to the user being authenticated and without further authentication of the user.

It is yet another aspect of the disclosure to provide a method of operating an entry system including an electric latch having an actuation group operable to latch and unlatch a closure panel of a vehicle using power from a main power source during a normal operating condition. The method includes the step of supplying power from a backup battery to a backup controller of an entry backup energy assembly in response to movement of an activation switch of the entry backup energy assembly to an activated state during a failure operating condition different from the normal operating condition. The next step of the method is wirelessly communicating with a user authentication unit carried by a user in communication with the backup controller to authenticate the user using the backup controller in response to power being supplied to the backup controller. The method proceeds by providing the backup electrical energy from the backup battery to a latch control unit and the actuation group of the electric latch using the backup controller. The method also includes the step of enabling the user to operate the electric latch during the failure operating condition in response to the movement of the activation switch to the activated state and the user being authenticated and without further authentication of the user.

These and other aspects and areas of applicability will become apparent from the description provided herein. The description and specific examples in this summary are intended for purpose of illustration only and are not intended to limit the scope of the present disclosure.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 is a partial schematic representation of a motor vehicle with a closure panel and an electric latch, according aspects of the disclosure;

FIG. 2 shows a closure panel of the motor vehicle equipped with an entry system including the electric latch, a capacitive sensor, a Body Control Module, a door presenter, and an entry backup energy assembly, according to aspects of the disclosure;

FIG. 3 is a block diagram of the entry backup energy assembly and the electric latch of the entry system of FIG. 2, according to aspects of the disclosure;

FIGS. 4A and 4B illustrate possible locations in the motor vehicle in which the entry backup energy assembly can be located, according to aspects of the disclosure;

FIGS. 5A and 5B illustrate an activation switch of the entry backup energy assembly comprising a handle switch of an outside handle of the motor vehicle, according to aspects of the disclosure;

FIGS. 6A and 6B illustrate arrangements of the entry backup energy assembly in an exterior rearview mirror of the motor vehicle according to aspects of the disclosure; and

FIGS. 7-9 illustrates steps of a method of operating the entry system according to aspects of the disclosure.

Corresponding reference numerals indicate corresponding parts throughout the various views of the drawings.

### DETAILED DESCRIPTION

In the following description, details are set forth to provide an understanding of the present disclosure. In some instances, certain circuits, structures and techniques have not been described or shown in detail in order not to obscure the disclosure.

In general, the present disclosure relates to an entry system of the type well-suited for use in many applications. More specifically, an entry system including an entry backup energy assembly and a method of operating the entry system are disclosed herein. The entry system and entry backup energy assembly of this disclosure will be described in conjunction with one or more example embodiments. However, the specific example embodiments disclosed are merely provided to describe the inventive concepts, features, advantages and objectives with sufficient clarity to permit those skilled in this art to understand and practice the disclosure.

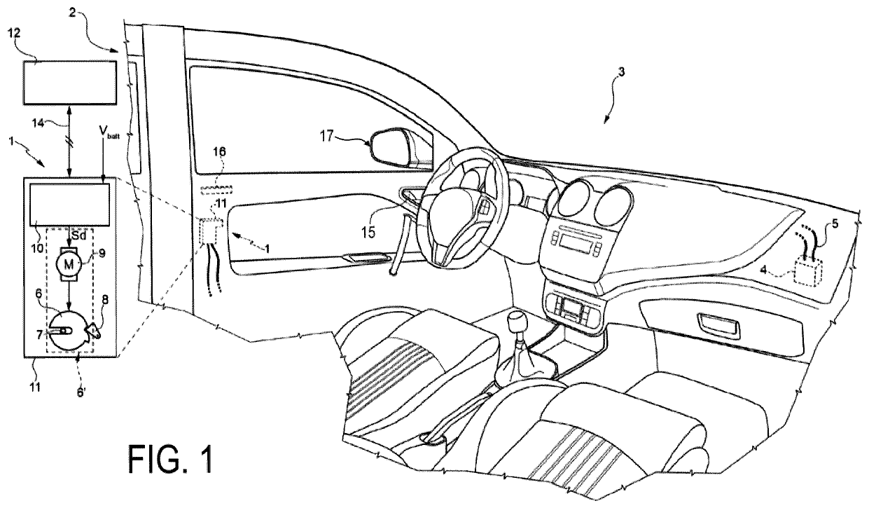

Referring to the Figures, wherein like numerals indicate corresponding parts throughout the several views, an electric latch 1, referred to as a “Smart Latch”, or e-latch, is coupled to a closure panel (e.g., side door 2) of a motor vehicle 3 in FIG. 1. However, it should be understood that the electric latch 1 may equally be coupled to any kind of closure device or panel of the motor vehicle 3. The electric latch 1 is electrically connected to a main power source 4 of the motor vehicle 3, for example a main battery illustratively providing a battery voltage Vbatt of 12 Volts, through an electrical connection element 5, for example, a power cable (the main power source 4 may equally include a different source of electrical energy within the motor vehicle 3, for example an alternator). The door 2 also includes an exterior rearview mirror 17.

The electric latch 1 includes at least one actuation group 6′ disposed within the latch housing 11, including a latch electric motor 9 operable to control actuation of the door 2 (or in general of the closure panel to latch and unlatch the closure panel). As shown, the at least one actuation group 6′ includes a ratchet 6, which is selectively rotatable to engage a striker 7 (fixed to the body of the motor vehicle 3, for example to the so called “A pillar” or “B pillar”, in a manner not shown in detail). When the ratchet 6 is rotated into a latching position with respect to the striker 7 (e.g., a primary position of the ratchet 6), the side door 2 is in a closed operating state. A pawl 8 selectively engages the ratchet 6 to prevent it from rotating, driven by the latch electric motor 9, so as to move between an engaged position and a non-engaged position, thereby providing a power release function. The latch electric motor 9 may be operated based on a release signal or open command (e.g., via operation of the inside door handle 15, outside door handle 16, detected presence of operator, etc.) in order to rotate to position the pawl 8 and/or ratchet 6 (and any other components of the actuation group 6′) into an appropriate position/state.

An additional electrical motor, or the latch electrical motor 9 may be provided to enable other latch functions other than a power release function. For example, the ratchet 6 may also be driven by the electrical motor in order to cinch the door 2 relative to the motor vehicle 3. In addition, the ratchet 6 may also be driven by the electrical motor in order to present the door 2 relative to the motor vehicle 3.

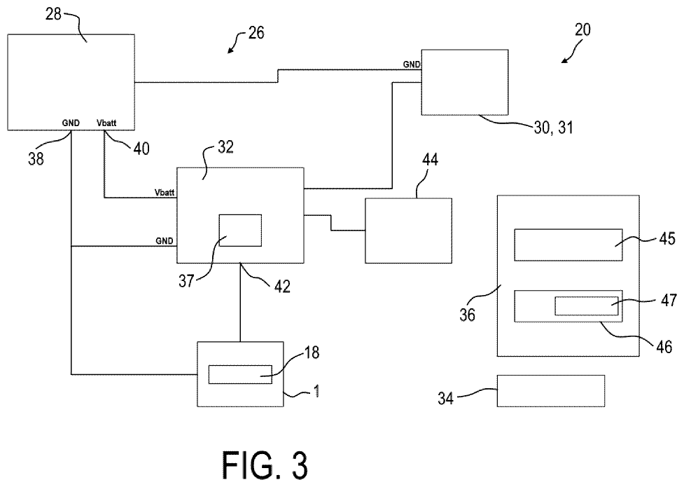

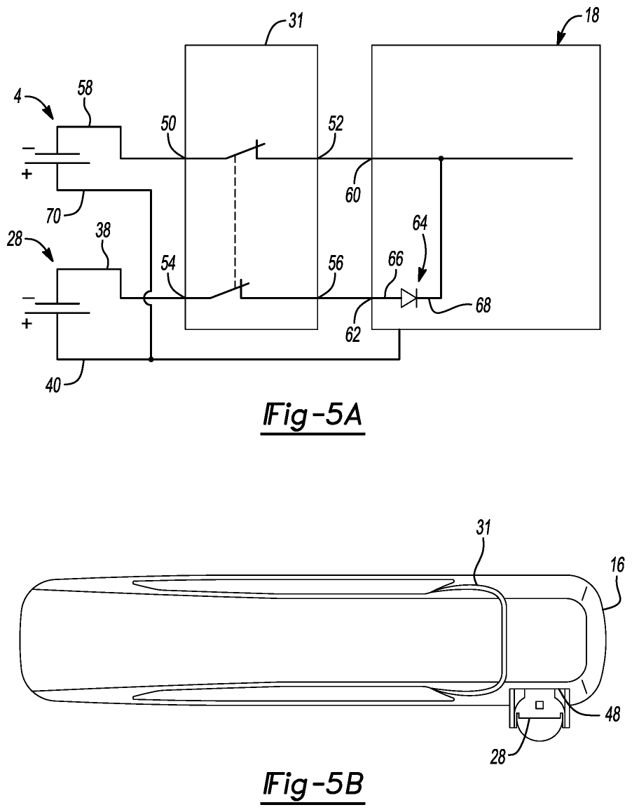

The electric latch 1 further includes an electronic control circuit 10, which may be conveniently embedded and arranged in a latch housing 11 (shown schematically) with the at least one actuation group 6′ of the electric latch 1, thus providing an integrated compact and easy-to-assemble unit. The electronic control circuit 10 is coupled to the latch electric motor 9 of the at least one actuation group 6′ and provides driving signals Sd thereto. The electronic control circuit 10 includes a latch control unit 18 (FIGS. 3 and 5), for example, provided as a microcontroller, microprocessor or analogous computing module. The latch control unit 18 is coupled to the actuation group 6′ of the electric latch 1 and operable to latch and unlatch the closure panel using power from the main power source 4 during a normal operating condition.

The electronic control circuit 10 may also be electrically coupled to a main vehicle management unit 12 (also known as main ECU or “vehicle body computer” or Body Control Module or BCM), which is configured to control general operation of the motor vehicle 3, via a data bus 14, so as to exchange signals, data, commands and/or information.

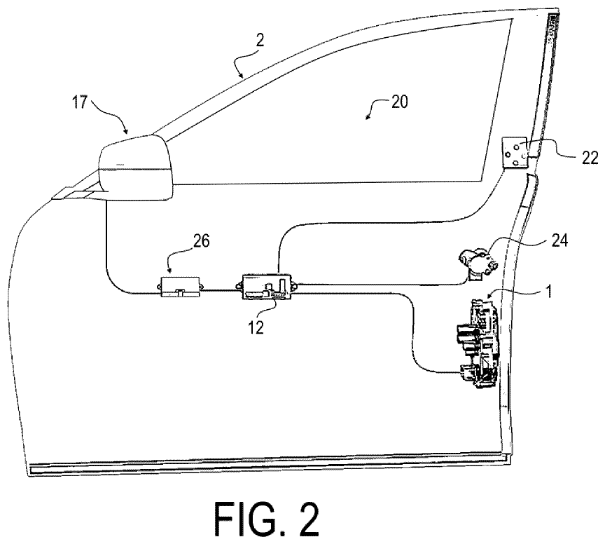

FIG. 2 illustrates door 2 of the motor vehicle 3 incorporating an exemplary entry system 20 for the door 2 including the electric latch 1. The entry system 20 can also include a capacitive sensor 22 associated with a keyless entry system and a door presenter 24 (which could alternatively be integrated into the electric latch 1, as described above) that moves and presents the door 2. The entry system 20 also includes an entry backup energy assembly 26 coupled to the electric latch 1.

During the normal operating condition, the capacitive sensor 22 may, for example, be configured to permit selective access to the motor vehicle 3 via door 2 when the operator (hereinafter, the “user”) enters an authorization code or makes a gesture via detected by the capacitive sensor 22. The authentication code entered can be transmitted to the latch control unit 18 (FIGS. 3 and 5) where it is compared to a correct or verification code stored in a memory. The latch control unit 18 may otherwise or also communicate with the other vehicle systems to transmit the entered authentication code for comparison by the vehicle systems (e.g., a vehicle authentication system or the Body Control Module 12) with the correct or verification code stored in a memory of the vehicle systems, or retrieve the correct or verification code from the vehicle systems for comparison by the latch control unit 18. If the entered passcode or authentication code matches the verification code stored in the memory unit, a signal is sent to latch control unit 18 to permit operation of outside handle 16 to release door 2 and allow access to the motor vehicle 3. Nevertheless, user authentication may take myriad forms during the normal operating condition.

As best shown in FIG. 3, the entry backup energy assembly 26 includes a backup battery 28 for providing backup electrical energy during a failure operating condition different from the normal operating condition. The backup battery 28 can store and provide power to the entry backup energy assembly 26 (and electric latch 1, as described in more detail below) in the event that the main power source 4, such as a main vehicle battery, cannot provide power. Such an event could occur during an emergency crash condition, an interruption to the electrical connection element 5 supplying power, or in the event of a depleted main vehicle battery (e.g., during an extended period in which the motor vehicle 3 is stored without use).

The entry backup energy assembly 26 also includes an activation switch 30, 31 electrically coupled to the backup battery 28 and moveable by a user to one of an activated state and a deactivated state. In addition, the entry backup energy assembly 26 includes a backup controller 32 coupled to the activation switch 30, 31 and the backup battery 28 and to the electric latch 1. The backup controller 32 is configured to execute software code and/or instructions stored on a memory unit integrated in or separate from the backup controller 32, such as an EEPROM, solid state disk, RAM, hard disk, other type of memory device, or the like. While the backup controller 32 is shown as being separate from the electric latch 1 including the latch control unit 18, it should be appreciated that the backup controller 32 could carry out the functions of the latch control unit 18 or the latch control unit 18 could operate as the backup controller 32.

The backup controller 32 is configured to receive power from the backup battery 28 in response to movement of the activation switch 30, 31 to the activated state. The backup controller 32 can then wirelessly communicate with a user authentication unit 34, 36 of the entry system 20 (e.g., via Bluetooth or Bluetooth low energy (BLE) 4.2) to authenticate the user. Thus, the backup controller 32 includes or is coupled to a wireless transceiver 37 (e.g., Bluetooth transceiver) in communication with the user authentication unit 34, 36. While Bluetooth is discussed herein, other types of wireless transceivers 37 are contemplated. The backup controller 32 provides the backup electrical energy from the backup battery 28 to the latch control unit 18 and the actuation group 6′ of the electric latch 1. Thus, the backup controller 32 enables the user to operate the electric latch 1 during the failure operating condition in response to the user being authenticated. According to an aspect, no further authentication of the user is required besides the wireless communication with the user authentication unit 34, 36 (e.g., no need to use a physical key with key teeth that match a key cylinder to authenticate). The backup controller 32 may also communicate with or control other vehicle systems (e.g., power release of a trunk or lift gate, actuation of the lights and/or security functions, and activation of the ignition system and/or the vehicle's heating system, etc.). The backup controller 32 can, for example, communicate with the Body Control Module 12, which may be responsible for monitoring and controlling various to electronic accessories of the motor vehicle 3, such as wireless access systems and devices (e.g., key fob, or passive keyless entry (PKE) based systems) and other authentication systems, such as capacitive sensor 22, and control other vehicle systems.

While the electric latch 1 may also utilize one or more backup power units (e.g., a local supercapacitor, or a battery) within latch housing 11 to allow its operation in the event that the main power source 4 is not available (e.g., in an emergency), such backup power units may also become depleted, leading to an inability to access an interior or compartment of the motor vehicle 3. Thus, the use of the entry backup energy assembly 26 described above can advantageously provide power to the latch control unit 18 as well as the actuation group 6′ of the electric latch 1. Therefore, the entry backup energy assembly 26 guarantees access to the motor vehicle 3, even if the main power source 4 is not available, and any backup power units of the electric latch 1 are also not able to provide power.

Still referring to FIG. 3, the backup battery 28 has a negative backup terminal 38 and a positive backup terminal 40. The activation switch 30, 31 is coupled between the negative backup terminal 38 and the backup controller 32. The backup controller 32 is also coupled to the positive backup terminal 40 and the negative backup terminal 38 of the backup battery 28 for receiving the backup electrical energy. The backup controller 32 provides the backup electrical energy to the electric latch 1 through a backup power output 42, while the electric latch 1 is also connected to the negative backup terminal 38 of the backup battery 28 (i.e., the backup controller 32 and electric latch 1 connected to the backup battery 28 through a parallel circuit). However, it should be understood that other arrangements of the backup battery 28, backup controller 32 and electric latch are contemplated.

The entry backup energy assembly 26 can further include an indicator light 44 coupled to the backup controller 32. Consequently, the backup controller 32 is further configured to light the indicator light 44 during authentication of the user. The indicator light 44 may, for example, comprise at least one light emitting diode (LED). The indicator light 44 can be used in other instances, such as, but not limited to providing feedback to the user regarding the movement of the activation switch 30, 31 to the activated state and/or indicating the state of charge of the backup battery 28 (e.g., illuminating with different colors depending on the activated state and/or indicating the state of charge of the backup battery 28).

The user authentication unit 34, 36 can be a key fob 34 and/or a mobile device 36. Specifically, the mobile device 36 could be a mobile phone executing an entry system application 46; however, it should be understood that the user authentication unit 34, 36 could take on other forms, such as, but not limited to other portable electronic devices. Credentials 45 used for user authentication may be stored on or entered through the mobile device 36. The entry system application 46 can provide instructions 47 to the user on the mobile device 36 for locating the activation switch 30, 31 of the entry backup energy assembly 26. In addition, the entry system application 46 can provide instructions 47 to the user on the mobile device 36 for replacing the backup battery 28 in the event that the backup battery 28 becomes depleted. It should be appreciated that the authentication of the user may alternatively or additionally be carried out with the capacitive sensor 22.

The backup battery 28 can include a plurality of replaceable lithium type batteries (e.g., two lithium 2032 type batteries providing 460 mAh power to the electric latch 1 and the backup controller 32). Such lithium type batteries can provide a projected ten year storage life. Alternatively, the backup battery 28 may be rechargeable (e.g., using energy from the main power source 4) using a separate changing circuit (not shown) coupled to the backup battery 28. Also, the backup controller 32 can further be configured to monitor an amount of backup electrical energy available from the backup battery 28. The backup controller 32 determines whether the amount of backup energy available is less than a predetermined backup energy threshold. The backup controller 32 can then send an alert to the entry system application 46 in response to determining the amount of backup energy available is less than the predetermined backup energy threshold.

During the authentication process, the backup controller 32 may, for example, operate with a sleep term having a length of two seconds and a transmitting and receiving (TX/RX) poll term of 20 milliseconds. During the sleep term, the backup controller 32 may only draw a low amount of current (e.g., 0.256 millamps) and the amount of current utilized during the transmitting and receiving poll term may increase (e.g., to 6.3 milliamps). The backup controller 32 can wake as a result of the user moving the activation switch 30, 31 to the activated state. The activation switch 30, 31 of the entry backup energy assembly 26 can, for example, be a momentary switch 30, 31.

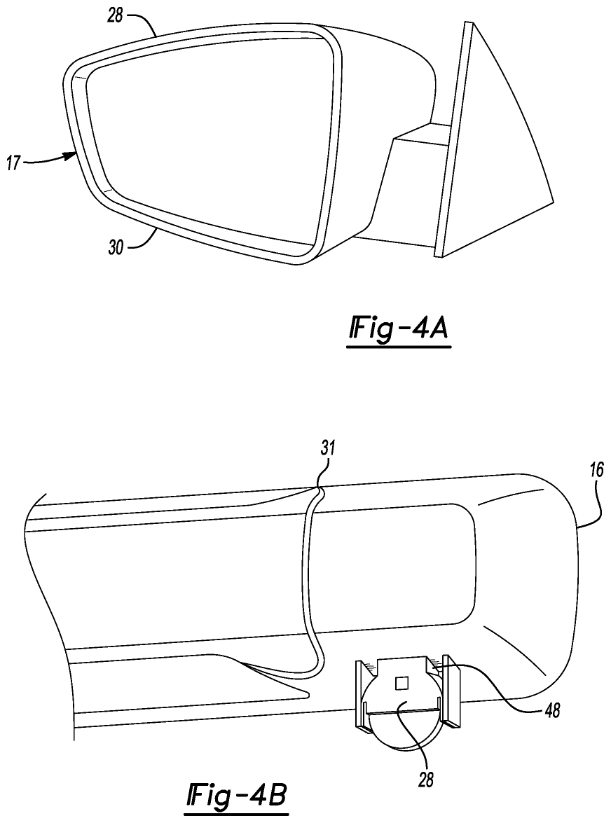

As best shown in FIG. 4A, the entry backup energy assembly 26 can be located in the exterior rearview mirror 17. So, at least one of the backup battery 28 and activation switch 30, 31 can be disposed in the exterior rearview mirror 17 of the vehicle. Alternatively, as best shown in FIG. 4B, the backup battery 28 can be disposed within a compartment 48 of the outside handle 16 of the closure panel (e.g., door 2) and the activation switch 30, 31 may comprise a handle switch 31 of the outside handle 16 connected via a protected usage circuit. In such a configuration, the handle switch 31 is moveable to the activated state in response to a movement of the outside handle 16 by the user (i.e., the user does not need to separately operate any other switch). Such an arrangement may provide more seamless use, than if a separate activation switch 30 is utilized. Nevertheless, both locations can advantageously offer protection from the environment and possible vandalism.

Referring to FIGS. 5A and 5B, the handle switch 31 can be a dual pole single throw switch 31 including a first input terminal 50 selectively connected to a first output terminal 52 in an on position for providing an activation signal to the latch control unit 18 during the normal operating condition. The dual pole single throw switch 31 can also include a second input terminal 54 selectively coupled to a second output terminal 56 in the on position for providing the activation signal to the latch control unit 18 (and/or backup controller 32) during the failure operating condition. In more detail, the first input terminal 50 is coupled to a negative main power terminal 58 of the main power source 4 and the second input terminal 54 is coupled to a negative backup terminal 38 of the backup battery 28. The first output terminal 52 is coupled to a first latch control input 60 of the latch control unit 18 and the second output terminal 56 is coupled to a second latch control input 62 of the latch control unit 18. The latch control unit 18 can further include a Schottky diode 64 having a diode anode 66 connected to the second latch control input 62 and a diode cathode 68 connected to the first latch control input 60 for preventing current flow from the first latch control input 60 to the second latch control input 62. The positive backup terminal 40 of the backup battery 28 and a positive main power terminal 70 are also connected to the latch control unit 18. While the handle switch 31 is shown as being connected to the latch control unit 18 as described above, it could alternatively or additionally be connected directly to the backup controller 32 (similar to the arrangement shown in FIG. 3). Therefore, the outside handle 16 can provide activation signals with every use during the normal operating condition; however, the electric latch 1 does not receive an emergency backup signal until all other power sources (e.g., the main power source 4 and/or any backup power units of the electric latch 1 itself) are depleted.

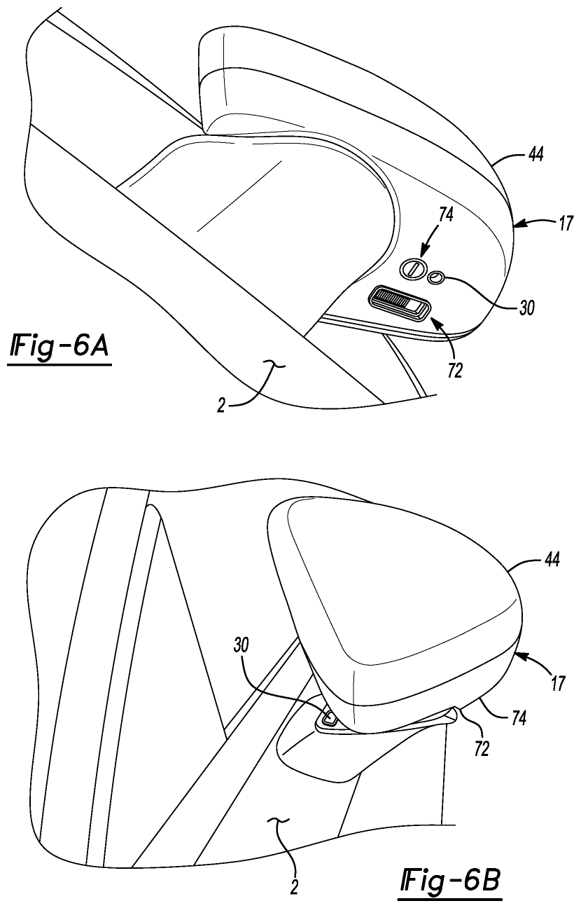

Now referring to FIG. 6A, an arrangement of the entry backup energy assembly 26 is shown located in the exterior rearview mirror 17. According to an aspect, the activation switch 30, 31 is a momentary switch 30 located on an underside of the exterior rearview mirror 17 of the motor vehicle 3. In addition, the exterior rearview mirror 17 also defines a battery receptacle housing 72 within the exterior rearview mirror 17 for containing the backup battery 28. The battery receptacle housing 72 is accessible from the underside of the exterior rearview mirror 17. A battery receptacle housing latch 74 is also disposed on the underside of the exterior rearview mirror 17 and is moveable between a lock position and a release position. The battery receptacle housing latch 74 is operably coupled to the battery receptacle housing 72 to release and engage the backup battery 28 for selectively securing the backup battery 28 within the battery receptacle housing 72. For example, the backup battery 28 can be locked in the battery receptacle housing 72 while the battery receptacle housing latch 74 is in the lock position. In addition, the battery receptacle housing 72 may include a spring loaded mechanism to eject the backup battery 28 in response to a movement of the battery receptacle housing latch 74 to the release position. The indicator light 44 may also be disposed in the exterior rearview mirror 17 (e.g., also serving as a side turn indicator) and flash during authentication. Thus, the user may conveniently access the backup battery 28 from outside the motor vehicle 3; however, any activation of the momentary switch 30 could be hidden from public view.

An alternative arrangement of the entry backup energy assembly 26 located in the exterior rearview mirror 17 is shown in FIG. 6B. Again, the exterior rearview mirror 17 may define the battery receptacle housing 72 within the exterior rearview mirror 17 and accessible from the underside of the exterior rearview mirror 17 for containing the backup battery 28. Also, like the arrangement shown in FIG. 6A, the indicator light 44 can be disposed in the exterior rearview mirror 17 and flash during authentication. However, instead of the momentary switch 30 being located on the underside of the exterior rearview mirror 17, it may instead be located on a portion of the exterior rearview mirror 17 that is only exposed when the exterior rearview mirror 17 is in a folded position. So, the user may still conveniently access the backup battery 28 from outside the motor vehicle 3; yet, the activation switch 30, 31 is hidden when the exterior rearview mirror 17 is unfolded.

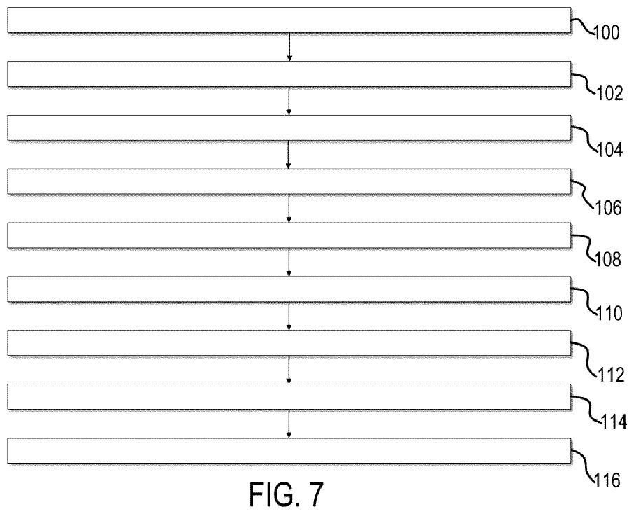

As best shown in FIGS. 7-9, a method of operating an entry system 20 is also provided. As discussed above, the entry system 20 includes an electric latch 1 having an actuation group 6′ operable to latch and unlatch a closure panel (e.g., door 2) of a motor vehicle 3 using power from a main power source 4 during a normal operating condition. So, in general, the method can include the step of 100 storing the backup electrical energy in a backup battery 28 of an entry backup energy assembly 26 (e.g., charging the backup battery 28 and/or putting the backup battery in the battery receptacle housing 72 of the exterior rearview mirror 17 or compartment of the outside handle 16). The method can continue with the step of 102 supplying power from a backup battery 28 to a backup controller 32 of the entry backup energy assembly 26 in response to movement of an activation switch 30, 31 of the entry backup energy assembly 26 to an activated state using a backup controller 32 of the entry backup energy assembly 26 during a failure operating condition different from the normal operating condition. The next step of the method is 104 wirelessly communicating with a user authentication unit 34, 36 carried by a user in communication with the backup controller 32 to authenticate the user using the backup controller 32 in response to power being supplied to the backup controller 32. The method may further include the step of 106 lighting an indicator light 44 coupled to the backup controller 32 during authentication of the user. The method then includes the step of 108 providing the backup electrical energy from the backup battery 28 to a latch control unit 18 and the actuation group 6′ of the electric latch 1 using the backup controller 32. The method also includes the step of 110 enabling the user to operate the electric latch 1 during the failure operating condition in response to the movement of the activation switch 30, 31 to the activated state and the user being authenticated. Again, no further authentication of the user may be required besides the wireless communication with the user authentication unit 34, 36 (e.g., no need to use a physical key with key teeth that match a key cylinder to authenticate). The method further can additionally include the step of 112 monitoring an amount of backup electrical energy available from the backup battery 28 using the backup controller 32. Next, 114 determining whether the amount of backup energy available is less than a predetermined backup energy threshold using the backup controller 32. Then, the method can include the step of 116 sending an alert to the entry system application 46 in response to determining the amount of backup energy available is less than the predetermined backup energy threshold.

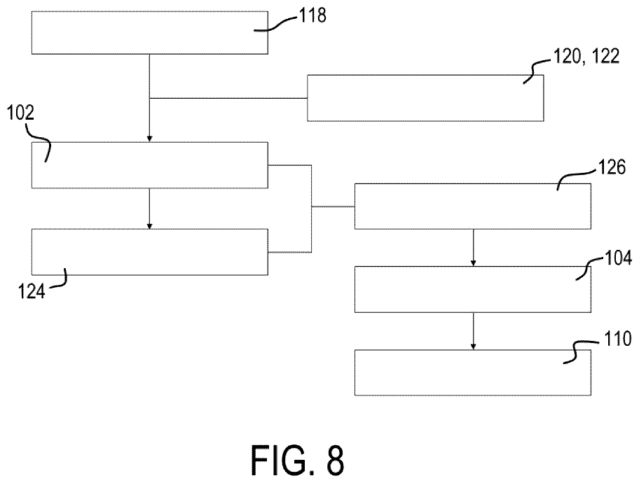

If the entry backup energy assembly 26 is located in the exterior rearview mirror 17 or another location in which the entry backup energy assembly 26 utilizes an activation switch 30 separate from the outside handle 16, the method can follow the steps shown in FIG. 8. The method includes the step of 118 the user approaching the motor vehicle 3 and being unable to open the door 2. The method continues with the step of 120 providing instructions 47 to the user to open the entry system application 46. The method further includes the step of 122 providing instructions 47 to the user on the mobile device 36 for locating the activation switch 30, 31 of the entry backup energy assembly 26 using the entry system application 46. The method can continue with the step of 102 supplying power from a backup battery to a backup controller 32 of the entry backup energy assembly 26 is response to movement of the activation switch 30, 31 of the entry backup energy assembly 26 to the activated state during the failure operating condition different from the normal operating condition. The method then includes the step of 124 detecting movement of the outside handle 16. Next, 126 powering the backup controller 32 and the electric latch 1 using the backup electrical energy from the backup battery 28. The next step of the method is 104 wirelessly communicating with the user authentication unit 34, 36 carried by a user in communication with the backup controller 32 to authenticate the user using the backup controller 32 in response to power being supplied to the backup controller 32. The method also includes the step of 110 enabling the user to operate the electric latch 1 during the failure operating condition in response to the movement of the activation switch 30, 31 to the activated state and the user being authenticated.

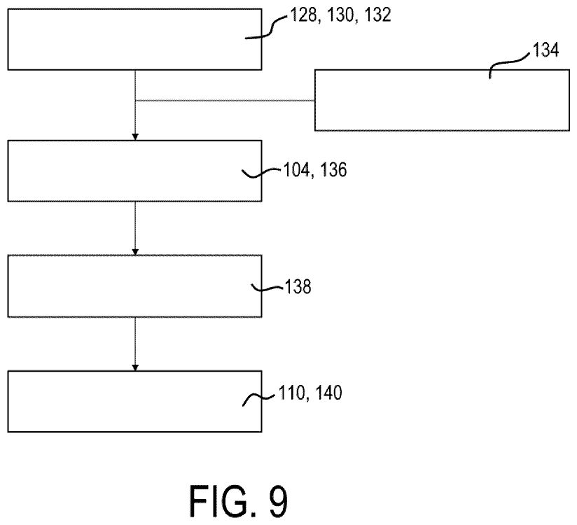

If the entry backup energy assembly 26 is located in the outside handle 16 of the motor vehicle 3 and the activation switch 30, 31 operates in conjunction with the outside handle 16 (the activation switch 30, 31 comprises the handle switch 31 of the outside handle 16), the method can follow the steps shown in FIG. 9. Specifically, the method includes the step of 128 the user approaching the motor vehicle 3 and pulling the outside handle 16 once. Thus, the method further includes the step of 130 moving the handle switch 31 to the activated state in response to a movement of the outside handle 16 by the user.

As discussed above, the handle switch 31 can be a dual pole single throw switch 31. Consequently, the method can include the step of connecting the first input terminal 50 of the dual pole single throw switch 31 coupled to the negative main power terminal 58 of the main power source 4 to the first output terminal 52 coupled to the latch control unit 18 in the on position in response to the movement of the outside handle 16 by the user. The method continues by providing an activation signal to a latch control unit 18 through the first output terminal 52 during the normal operating condition. The next step of the method is connecting the second input terminal 54 of the dual pole single throw switch 31 coupled to a negative backup terminal 38 of the backup battery 28 to a second output terminal 56 coupled to the latch control unit 18 in the on position in response to the movement of outside handle 16 by the user. The method then includes the step of providing the activation signal to the latch control unit 18 through the second output terminal 56 during the failure operating condition.

The step of 110 enabling the user to operate the electric latch 1 during the failure operating condition in response to the movement of the activation switch 30, 31 to the activated state and the user being authenticated can include the step of 132 connecting the second input terminal 54 of the dual pole single throw switch 31 coupled to the negative backup terminal 38 of the backup battery 28 to the second output terminal 56 coupled to the latch control unit 18 in the on position in response to a first movement of the outside handle 16 by the user (i.e., the user operates the outside handle 16 a first time). Next, 134 powering the backup controller 32 and electric latch 1 using the backup electrical energy from the backup battery 28. The method can then include the step of 136 awaiting authentication of the user after the first movement of the outside handle 16 by the user. The method can then continue with the step of 138 connecting the second input terminal 54 of the dual pole single throw switch 31 coupled to the negative backup terminal 38 of the backup battery 28 to the second output terminal 56 coupled to the latch control unit 18 in the on position in response to a second movement (i.e., the user operates the outside handle 16 a second time) of the outside handle 16 by the user. The next step of the method is 140 enabling the user to unlatch the closure panel with the electric latch 1 in response to the second movement of the outside handle 16 by the user and the user being authenticated.

Clearly, changes may be made to what is described and illustrated herein without departing from the scope defined in the accompanying claims. The entry system 20 and entry backup energy assembly 26 may be operable for any kind of different closure device incorporated within the motor vehicle 3, for example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with the example entry system 20 and entry backup energy assembly 26 can likewise be implemented into many other systems to power one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 180 degrees or at other orientations) and the spatially relative descriptions used herein interpreted accordingly.

What is claimed is:

1. An entry backup energy assembly for an electric latch powered by a main power source during a normal operating condition for a closure panel of a motor vehicle, comprising:
a backup battery for providing backup electrical energy during a failure operating condition different from the normal operating condition;
an activation switch electrically coupled to the backup battery and moveable by a user to one of an activated state and a deactivated state;
a backup controller coupled to the activation switch and the backup battery and to the electric latch and configured to:
receive power from the backup battery in response to movement of the activation switch to the activated state,
wirelessly communicate with a user authentication unit to authenticate the user, and
provide the backup electrical energy from the backup battery to the electric latch and enable the user to operate the electric latch during the failure operating condition in response to the user being authenticated and without further authentication of the user.

2. The entry backup energy assembly as set forth in claim 1, further including an indicator light coupled to the backup controller and wherein the backup controller is further configured to light the indicator light during authentication of the user.

3. The entry backup energy assembly as set forth in claim 1, wherein the user authentication unit is a mobile device executing an entry system application and the backup controller is further configured to:
monitor an amount of backup electrical energy available from the backup battery,
determine whether the amount of backup energy available is less than a predetermined backup energy threshold, and
send an alert to the entry system application in response to determining the amount of backup energy available is less than the predetermined backup energy threshold.

4. The entry backup energy assembly as set forth in claim 1, wherein the backup battery has a negative backup terminal and a positive backup terminal and the activation switch is coupled between the negative backup terminal and the backup controller and the backup controller is coupled to the positive backup terminal and the negative backup terminal of the backup battery for receiving the backup electrical energy.

5. An entry system for a closure panel of a motor vehicle, comprising:
an electric latch including and controlled by a latch control unit and including an actuation group coupled to the latch control unit and operable to latch and unlatch the closure panel using power from a main power source during a normal operating condition;
an entry backup energy assembly coupled to the electric latch and including a backup battery for storing backup electrical energy and an activation switch electrically coupled to the backup battery and moveable by a user to one of an activated state and a deactivated state for providing the backup electrical energy during a failure operating condition different from the normal operating condition;
a user authentication unit carried by the user;
the entry backup energy assembly including a backup controller in communication with the user authentication unit and coupled to the activation switch and the backup battery and coupled to the electric latch and configured to:
receive power from a backup battery in response to movement of the activation switch to the activated state,
wirelessly communicate with the user authentication unit to authenticate the user, and
provide the backup electrical energy from the backup battery to the latch control unit and the actuation group of the electric latch and enable operation of the electric latch during the failure operating condition in response to the user being authenticated and without further authentication of the user.

6. The entry system as set forth in claim 5, wherein the user authentication unit is a mobile device executing an entry system application.

7. The entry system as set forth in claim 6, wherein the entry system application is configured to provide instructions to the user on the mobile device for locating the activation switch of the entry backup energy assembly.

8. The entry system as set forth in claim 5, wherein the user authentication unit is a key fob.

9. The entry system as set forth in claim 5, wherein the activation switch of the entry backup energy assembly comprises a handle switch of an outside handle of the closure panel, the handle switch is moveable to the activated state in response to a movement of the outside handle by the user.

10. The entry system as set forth in claim 9, wherein the handle switch is a dual pole single throw switch including a first input terminal selectively connected to a first output terminal in an on position for providing an activation signal to the latch control unit during the normal operating condition and including a second input terminal selectively coupled to a second output terminal in the on position for providing the activation signal to the latch control unit during the failure operating condition, the first input terminal is coupled to a negative main power terminal of the main power source and the second input terminal is coupled to a negative backup terminal of the backup battery and the first output terminal is coupled to a first latch control input of the latch control unit and the second output terminal is coupled to a second latch control input of the latch control unit.

11. The entry system of claim 10, wherein the latch control unit further includes a Schottky diode having a diode anode connected to the second latch control input and a diode cathode connected to the first latch control input for preventing current flow from the first latch control input 60 to the second latch control input.

12. The entry system as set forth in claim 5, wherein the activation switch of the entry backup energy assembly is a momentary switch disposed in an exterior rearview mirror of the motor vehicle.

13. The entry system as set forth in claim 5, wherein the backup battery includes a plurality of lithium type batteries.

14. A method of operating an entry system including an electric latch having an actuation group operable to latch and unlatch a closure panel of a motor vehicle using power from a main power source during a normal operating condition, the method comprising the steps of:
supplying power from a backup battery to a backup controller of an entry backup energy assembly in response to movement of an activation switch of the entry backup energy assembly to an activated state during a failure operating condition different from the normal operating condition;
wirelessly communicating with a user authentication unit carried by a user in communication with the backup controller to authenticate the user using the backup controller in response to power being supplied to the backup controller;
providing the backup electrical energy from a backup battery to a latch control unit and the actuation group of the electric latch using the backup controller; and
enabling the user to operate the electric latch during the failure operating condition in response to the movement of the activation switch to the activated state and the user being authenticated and without further authentication of the user.

15. The method as set forth in claim 14, further including the step of lighting an indicator light coupled to the backup controller during authentication of the user.

16. The method as set forth in claim 14, wherein the activation switch of the entry backup energy assembly comprises a handle switch of an outside handle of the closure panel and the method further includes the step of moving the handle switch to the activated state in response to a movement of the outside handle by the user.

17. The method as set forth in claim 16, wherein the handle switch is a dual pole single throw switch and the method further includes the steps of:
connecting a first input terminal of the dual pole single throw switch coupled to a negative main power terminal of the main power source to a first output terminal coupled to a latch control unit in an on position in response to the movement of the outside handle by the user;
providing an activation signal to the latch control unit through the first output terminal during the normal operating condition;
connecting a second input terminal of the dual pole single throw switch coupled to a negative backup terminal of the backup battery to a second output terminal coupled to the latch control unit in the on position in response to the movement of outside handle by the user; and
providing the activation signal to the latch control unit through the second output terminal during the failure operating condition.

18. The method as set forth in claim 17, wherein the step of enabling the user to operate the electric latch during the failure operating condition in response to the movement of the activation switch to the activated state and the user being authenticated includes the steps of:
connecting the second input terminal of the dual pole single throw switch coupled to the negative backup terminal of the backup battery to the second output terminal coupled to the latch control unit in the on position in response to a first movement of the outside handle by the user;
awaiting authentication of the user after the first movement of the outside handle by the user;
connecting the second input terminal of the dual pole single throw switch coupled to the negative backup terminal of the backup battery to the second output terminal coupled to the latch control unit in the on position in response to a second movement of the outside handle by the user; and
enabling the user to unlatch the closure panel with the electric latch in response to the second movement of the outside handle by the user and the user being authenticated.

19. The method as set forth in claim 14, wherein the user authentication unit is a mobile device executing an entry system application and the method further includes the step of providing instructions to the user on the mobile device for locating the activation switch of the entry backup energy assembly using the entry system application.

20. The method as set forth in claim 14, wherein the user authentication unit is a mobile device executing an entry system application and the method further includes the steps of:
monitoring an amount of backup electrical energy available from the backup battery using the backup controller;
determining whether the amount of backup energy available is less than a predetermined backup energy threshold using the backup controller; and
sending an alert to the entry system application in response to determining the amount of backup energy available is less than the predetermined backup energy threshold.

21. The entry system as set forth in claim 5, wherein the activation switch of the entry backup energy assembly is disposed on an underside of an exterior rearview mirror of the motor vehicle.

22. The entry system as set forth in claim 5, wherein the backup battery of the entry backup energy assembly is disposed in an exterior rearview mirror of the motor vehicle.

23. The entry system as set forth in claim 22, wherein the backup battery of the entry backup energy assembly is an interchangeable back up battery and is provided in an exteriorly accessible compartment disposed in the exterior rearview mirror of the motor vehicle.
